(19) United States
(12) Patent Application Publication
(10) Pub. No.: US 2025/0148766 A1
(43) Pub. Date: May 8, 2025

(54) LEVERAGING SEMANTIC INFORMATION FOR A MULTI-DOMAIN VISUAL AGENT

(71) Applicant: NEC Laboratories America, Inc., Princeton, NJ (US)

(72) Inventors: Vijay Kumar Baikampady Gopalkrishna, Santa Clara, CA (US); Masoud Faraki, Redwood City, CA (US); Yumin Suh, Santa Clara, CA (US); Manmohan Chandraker, Santa Clara, CA (US)

(21) Appl. No.: 18/934,756

(22) Filed: Nov. 1, 2024

Related U.S. Application Data
(60) Provisional application No. 63/595,912, filed on Nov. 3, 2023.
(60) Provisional application No. 63/562,292, filed on Mar. 7, 2024.

(51) Int. Cl. G06V 10/774; B60W 60/00; G06F 40/284; G06F 40/30; G06V 10/86; G06V 20/56

(52) U.S. Cl. CPC G06V 10/774; B60W 60/001; G06F 40/284; G06F 40/30; G06V 10/86; G06V 20/56

(57) ABSTRACT

Systems and methods for leveraging semantic information for a multi-domain visual agent. Semantic information can be leveraged to obtain a multi-domain visual agent. To train the multi-domain visual agent, questions can be sampled from question templates for domain-specific label spaces to obtain a unified label space. The domain-specific labels from the domain-specific label spaces can be mapped into natural language descriptions (NLD) to obtain mapped NLD. The mapped NLD can be converted into prompts by combining the questions sampled from the unified label space and the annotations. The semantic information can be learned by iteratively generating outputs from tokens extracted from the prompts using a large-language model (LLM). The multi-domain visual agent (MDVA) can be trained using the semantic information.

### RELATED APPLICATION INFORMATION

This application claims priority to U.S. Provisional App. No. 63/595,912, filed on Nov. 3, 2023, and to U.S. Provisional App. No. 63/562,292, filed on Mar. 7, 2024, incorporated herein by reference in their entirety.

### BACKGROUND

### Technical Field

The present invention relates to multi-modality reasoning and generation using artificial intelligence models and more particularly to leveraging semantic information for a multi-domain visual agent.

### Description of the Related Art

Artificial intelligence (AI) models have improved dramatically over the years especially in entity detection, scene reconstruction, trajectory generation, and scene understanding. However, the accuracy of the AI models are directly proportional to the quality of data that they are trained with. As a result of poor-quality data, AI models can generate hallucinations which can include outputs that are irrelevant to the input data. Thus, improving the quality of training data for the AI models is an important issue that still needs to be addressed in AI models.

### SUMMARY

According to an aspect of the present invention, a computer-implemented method is provided for leveraging semantic information for a multi-domain visual agent, including, sampling questions from question templates for domain-specific label spaces to obtain a unified label space, mapping domain-specific labels from the domain-specific label spaces into natural language descriptions (NLD) to obtain mapped NLD, generating prompts by combining the questions sampled from the unified label space and the mapped NLD, learning the semantic information by iteratively generating outputs from tokens extracted from the prompts using a large-language model (LLM), and training the multi-domain visual agent (MDVA) using the semantic information to obtain a trained MDVA.

According to another aspect of the present invention, a system is provided for leveraging semantic information for a multi-domain visual agent, including, a memory device, one or more processor devices operatively coupled with the memory device to sample questions from question templates for domain-specific label spaces to obtain a unified label space, map domain-specific labels from the domain-specific label spaces into natural language descriptions (NLD) to obtain mapped NLD, generate prompts by combining the questions sampled from the unified label space and the mapped NLD, learn the semantic information by iteratively generating outputs from tokens extracted from the prompts using a large-language model (LLM), and train the multi-domain visual agent (MDVA) using the semantic information to obtain a trained MDVA.

According to yet another aspect of the present invention, a non-transitory computer program product is provided including a computer-readable storage medium having program code for leveraging semantic information for a multi-domain visual agent, wherein the program code when executed on a computer causes the computer to sample questions from question templates for domain-specific label spaces to obtain a unified label space, map domain-specific labels from the domain-specific label spaces into natural language descriptions (NLD) to obtain mapped NLD, generate prompts by combining the questions sampled from the unified label space and the mapped NLD, learn the semantic information by iteratively generating outputs from tokens extracted from the prompts using a large-language model (LLM), and train the multi-domain visual agent (MDVA) using the semantic information to obtain a trained MDVA.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level overview of a computer-implemented method for leveraging semantic information for a multi-domain visual agent, in accordance with an embodiment of the present invention;

FIG. 2 is a block diagram showing a system implementing practical applications of the method of leveraging semantic information for a multi-domain visual agent, in accordance with an embodiment of the present invention;

FIG. 3 is a block diagram illustrating a computing system for leveraging semantic information for a multi-domain visual agent is illustratively depicted in accordance with an embodiment of the present invention;

FIG. 4 is a block diagram showing a hardware and software components of leveraging semantic information for a multi-domain visual agent, in accordance with an embodiment of the present invention; and

FIG. 5 is a block diagram illustrating deep learning neural networks for leveraging semantic information for a multi-domain visual agent, in accordance with an embodiment of the present invention.

### DETAILED DESCRIPTION OF PREFERRED EMBODIMENTS

In accordance with embodiments of the present invention, systems and methods are provided for leveraging semantic information for a multi-domain visual agent.

In an embodiment, semantic information can be leveraged to obtain a multi-domain visual agent. To train the multi-domain visual agent, questions can be sampled from question templates for domain-specific label spaces to obtain a unified label space. The domain-specific labels from the domain-specific label spaces can be mapped into natural language descriptions (NLD) to obtain mapped NLD. The mapped NLD can be converted into prompts by combining the questions sampled from the unified label space and the annotations. The semantic information can be learned by iteratively generating outputs from tokens extracted from the prompts using a large-language model (LLM). The multi-domain visual agent (MDVA) can be trained using the semantic information.

The trained MDVA can be employed to perform downstream tasks such as object detection, accident detection, facilitating visually grounded conversations, etc.

Recently, there has been a great progress in learning multi-modal large language models (MLLMs) that follows natural language instructions effectively to accomplish many real-world computer vision tasks. This progress has been driven by at least the following factors: the availability of large datasets of natural images, and the development of large language models like GPT-3™, which can be used to generate training data with richer annotations using in-context examples. However, these models still face certain at least the following challenges:

Hallucination: models can sometimes generate responses that are inconsistent and irrelevant with the input image. For example, a model might be asked to describe an image of a cat, but it might generate a response that describes a dog instead.

Domain-specific training: training MLLMs for domain-specific tasks can be challenging due to the limited availability expert annotations. For example, training a model to provide a detailed description of medical images would require a large dataset of labeled medical images (long descriptions), which can be difficult and expensive to obtain.

The present embodiments can enhance the capabilities MLLMs in generating outputs that exhibit a stronger connection to input images. Specifically, the present embodiments can leverage semantic representations of the image obtained with existing domain-specific models such as localization information (detection), visual attributes etc. The present embodiments can incorporate these information alongside the input image and user instructions to guide the MLLM in generating output responses that are inherently grounded in the visual content.

The utilization of semantic information from images offers at least the following advantages:

Improving the reasoning abilities of MLLM by considering the contextual cues (ex: objects and their spatial relationships, actions etc.) which can be inferred from the semantic representation of the image

Adaptability of the MLLM through various domains can be improved by transferring learned knowledge through the analysis of context (within semantic information) to other domains. For instance, in the case of satellite imagery, if a playground is observed adjacent to a building, the model can infer that the building is likely a school, showcasing the potential for knowledge transfer across different application domains.

Reduction of hallucinations by improving the semantic understanding of MLLM by interpreting high-level semantic details (text) embedded within images, such as color, shape, object names, actions, and spatial locations.

Thus, the present embodiments improve the reasoning abilities of MLLMs, the adaptability of MLLMs through various domains, and reduction of hallucinations for MLLMs by leveraging semantic information from images.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

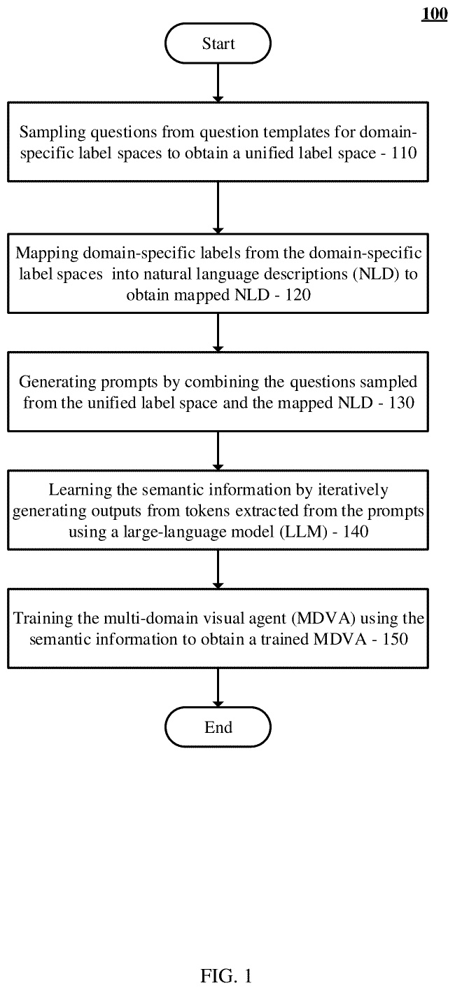

Referring now in detail to the figures in which like numerals represent the same or similar elements and initially to FIG. 1, a high-level overview of a computer-implemented method for leveraging semantic information for a multi-domain visual agent is illustratively depicted in accordance with one embodiment of the present invention.

In an embodiment, semantic information can be leveraged to obtain a multi-domain visual agent. To train the multi-domain visual agent, questions can be sampled from question templates for domain-specific label spaces to obtain a unified label space. The domain-specific labels from the domain-specific label spaces can be mapped into natural language descriptions (NLD) to obtain mapped NLD. The mapped NLD can be converted into prompts by combining the questions sampled from the unified label space and the annotations. The semantic information can be learned by iteratively generating outputs from tokens extracted from the prompts using a large-language model (LLM). The multi-domain visual agent (MDVA) can be trained using the semantic information.

The trained MDVA can be employed to perform downstream tasks such as object detection, accident detection, facilitating visually grounded conversations, etc.

Referring now to block 110 of FIG. 1 showing an embodiment of a method for sampling questions from domain-specific label spaces to obtain a unified label space.

The questions can be sampled from question templates for domain-specific label spaces. Question templates can be tailored for the domain-specific label spaces based on relevance to the domain-specific label spaces. For example, a question template for an object detection label space can include “Based on [object detection attribute], what objects are [present/not present] in the image?” The object detection attribute can include bounding box coordinates, object size, object color, object label, etc.

The domain-specific label spaces can include domain-specific labels such as pairs of annotations and modalities for respective domains. For example, for object detection for traffic scenes, its corresponding label space can include images and respective annotations that can include bounding boxes, categories (e.g., road, vehicles, buildings, traffic signs, etc.), object labels, object attribute descriptions, etc. The domain-specific label spaces can be obtained from domain-specific datasets such as Road++ dataset, RefCOCO dataset, NuScenes, NuScenes-QA, Traffic Accident Benchmark for Causality Recognition, Car Crash Dataset, etc.

To obtain a unified label space, the questions for the domain-specific label spaces are sampled and the corresponding domain-specific label spaces are merged. The sampling method can be heuristics-based. For example, in the traffic scene domain, the sampling rules can include that categories, and its corresponding attributes, that exceed a commonality threshold is sampled. The commonality threshold can include determining the number of times the same category can be detected in different traffic scenes. In another example for natural language expression for images, all accessible annotations can be sampled. In another example, categories that can be detected (e.g., visible from the scene) are sampled. The sampling rules, domain-specific labels and corresponding samples can be stored in a database.

In another embodiment, the questions are randomly sampled until a sampling threshold has been reached. The sampling threshold can be a natural number such as one hundred, five hundred, etc.

Referring now to block 120 of FIG. 1 showing an embodiment of a method for mapping the domain-specific labels from the domain-specific label spaces into natural language descriptions (NLD) to obtain mapped NLD.

The natural language descriptions (NLD) can include text that describes a ground truth from the domain-specific label space. The NLD can also include heuristics for the domain-specific label space. For example, the NLD for an object detection label space for traffic scenes can include “The normalized bounding box coordinates are expressed in a way that is independent of the actual image size, instead of using pixel values normalized coordinates are represented as relative values, usually ranging from 0 to 1.” The NLD can be generated by a large language model (LLM) based on a NLD prompt. The NLD prompt can be “Generate a caption for this image based on [heuristics], [ground truth].”

The mapping method can be based on similarity between the NLD and the domain-specific labels. The similarity can be based on the semantic meaning of the NLD and the domain specific labels can be determined using determined word embeddings using a word embedding model such as Word2Vec, GloVe, and FastText. The word embeddings can then be compared using cosine similarity.

In another embodiment, text similarity between the NLD and the domain-specific labels can be obtained by transformer-based models such as BERT, CLIP, etc.

Referring now to block 130 of FIG. 1 showing an embodiment of a method for generating prompts by combining the questions sampled from the unified label space and the mapped NLD.

The prompt template can be obtained from a database that includes pre-made templates for each domain-specific label space. For example, the prompt template can include “[question], here is a description: [NLD], here are some examples: [input data].” To generate a prompt, the prompt template can be combined with the questions, the NLD, and some input data. In another embodiment, the prompt template can be fine-tuned for each based on the learned semantic information between each question, NLD, and input data to increase the accuracy score of the generated output during the verification step. The verification step will be discussed in block 140. The semantic information can include object attributes (e.g., color, shape, labels, names, etc.), spatial relationships, semantic meaning (e.g., action, specialized meaning within the domain, ordinary meaning, etc.) of the objects within an image, etc.

Referring now to block 140 of FIG. 1 showing an embodiment of a method for learning the semantic information from the prompts by employing a large-language model (LLM).

The LLM can be fine-tuned to learn the semantic information from the prompts. The LLM can iteratively generate outputs from tokens of text extracted from the prompt that includes the semantic information to fine-tune its knowledge of the semantic information. For example, for the LLM to learn the semantic information for an image using a prompt of “a dog having black ears and white fur”, the LLM can generate outputs for the token “dog,” then the LLM can filter its outputs of “dogs with black ears,” then the LLM can filter its outputs of “dogs with black ears and white fur.” By doing so, the LLM can iteratively learn the semantic information of the input text and its corresponding images. The generated output can include an image, NLD, and object attributes.

The generated output by the LLM can be verified by an expert. The expert can be a pre-trained model for the respective domain-space. In another embodiment, the expert can be a human annotator. The LLM can be a vision large language model such as GPT™, BERT™, etc. The learned semantic information can be converted into NLD, annotations and can be mapped to a corresponding input image as verified input pairs.

To verify the learned semantic information, a loss function can be computed between the generated outputs and ground truth data from the unified label space. The loss function can be next token prediction loss. The verified generated outputs with their corresponding prompts including questions, NLD, and input data can be employed to train the MDVA.

Referring now to block 150 of FIG. 1 showing an embodiment of a method for training the multi-domain visual agent (MDVA) using the semantic information, prompts, unified label space and annotations to obtain a trained MDVA.

The MDVA can include a visual encoder, a text encoder, and a multi-modal fusion module. The visual encoder can be a convolutional neural network or vision transformer model. The text encoder can be a transformer-based model. The multi-modal fusion module can employ attention mechanisms such as cross-attention layers to fuse the outputs of the visual encoder and the text encoder.

To train the MDVA, the verified input pairs can be tokenized to separate the input image to the input text. The input image from the verified input pairs can be converted to visual embeddings by the visual encoder. The input text from the verified input pairs can be converted to text embeddings by the text encoder. The visual embeddings and the text embeddings can be fused by the multi-modal fusion module.

Due to the learned semantic information, the trained MDVA can transfer its knowledge from one domain to another by generating output that includes an output image and the corresponding, question, NLD, annotation for a specific domain. For example, in the case of satellite images as input for object detection, if a playground is observed adjacent to a building, the MDVA can infer that the building is likely a school. Using the same image but for a different domain such as traffic scene reconstruction, because the building inferred is likely a school, the MDVA can infer that the roadways around it can have a speed limit of twenty miles per hour from seven in the morning until seven in the evening.

In another embodiment, the MDVA can be trained iteratively until a training threshold has been met. The training threshold can be a pre-determined natural number such as five, ten, twenty, etc.

The trained MDVA can be used for other domain-specific tasks such as fine-grained object detection, traffic scene understanding for autonomous vehicles, accident detection, image synthesis, etc.

Thus, by leveraging semantic information from images, the present embodiments improve the reasoning abilities of MLLMs, the adaptability of MLLMs through various domains, and reduction of hallucinations for MLLMs.

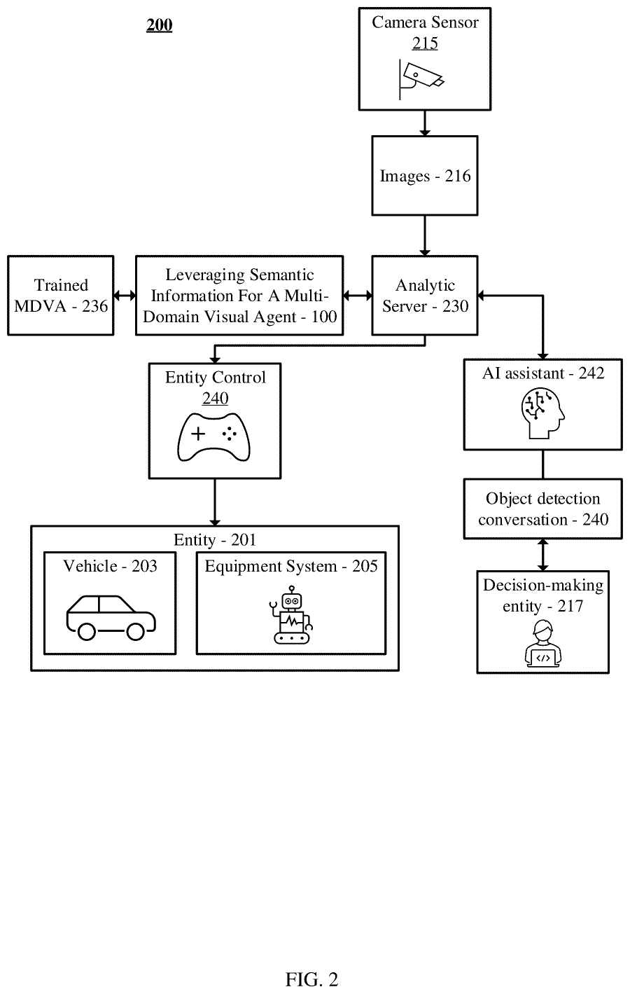

Referring now to FIG. 2, a block diagram showing a system implementing practical applications of the method of leveraging semantic information for a multi-domain visual agent, in accordance with an embodiment of the present invention.

System 200 can be employed to perform several domain-specific tasks such as entity control 240 and object detection conversation 240. The system 200 can include a camera sensor 215 to collect images 216. The images 216 can be sent to an analytic server 230 over a network. The analytic server 230 can include an implementation of the method of leveraging semantic information for a multi-domain visual agent 100.

The analytic server 230 can generate domain-specific actions such as the entity control 240 and the object detection conversation 240. In another embodiment, the entity control 240 can include controlling an entity 205 such as a vehicle 203 or an equipment system 205. For the vehicle 203, the entity control 240 can be braking, speeding up, changing directions, etc. with an advanced driver assistance system (ADAS). The entity control 240 for the vehicle 203 can be dependent on a traffic scene trajectory for a traffic scene composed of detected objects generated by the analytic server 230.

In another embodiment, the equipment system 205 can be a manufacturing system for products. The entity control 240 for the equipment system 205 can include redirecting the product from a different workflow base on the detected semantic information of the images of the products such as color of the product, the type of product, size of the product, etc.

In another embodiment, the object detection conversation 240 can include a decision-making entity 217 interacting with an artificial intelligence (AI) assistant 242 to ask a question about the image 216. For example, the question can be domain-specific, such as in traffic scene understanding, which can include “How many blue cars that ran the speed light are in this image?” The AI assistant 242 can then answer the question based on the blue cars that ran the speed light the trained MDVA 236 detected.

In another embodiment, the trained MDVA 236 can generate synthesized images based on the request of the decision-making entity 217.

Other practical applications are contemplated.

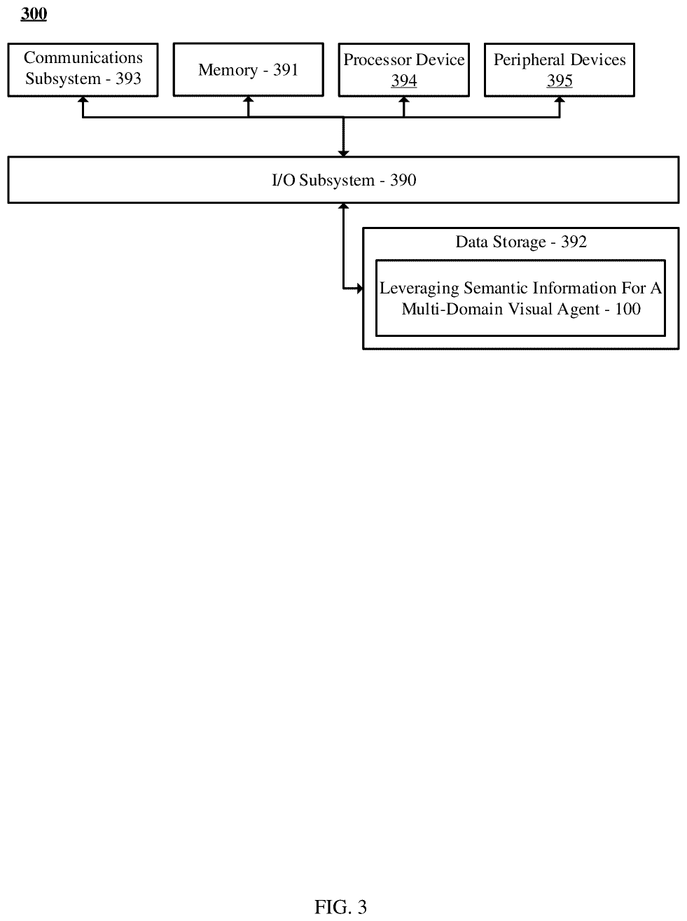

Referring now to FIG. 3, a computing system for leveraging semantic information for a multi-domain visual agent is illustratively depicted in accordance with an embodiment of the present invention.

The computing device 300 illustratively includes the processor device 394, an input/output (I/O) subsystem 390, a memory 391, a data storage device 392, and a communication subsystem 393, and/or other components and devices commonly found in a server or similar computing device. The computing device 300 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 391, or portions thereof, may be incorporated in the processor device 394 in some embodiments.

The processor device 394 may be embodied as any type of processor capable of performing the functions described herein. The processor device 394 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 391 may be embodied as any type of volatile or non-volatile memory or data storage capable of performing the functions described herein. In operation, the memory 391 may store various data and software employed during operation of the computing device 300, such as operating systems, applications, programs, libraries, and drivers. The memory 391 is communicatively coupled to the processor device 394 via the I/O subsystem 390, which may be embodied as circuitry and/or components to facilitate input/output operations with the processor device 394, the memory 391, and other components of the computing device 300. For example, the I/O subsystem 390 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 390 may form a portion of a system-on-a-chip (SOC) and be incorporated, along with the processor device 394, the memory 391, and other components of the computing device 300, on a single integrated circuit chip.

The data storage device 392 may be embodied as any type of device or devices configured for short-term or long-term storage of data such as, for example, memory devices and circuits, memory cards, hard disk drives, solid state drives, or other data storage devices. The data storage device 392 can store program code for leveraging semantic information for a multi-domain visual agent 100. Any or all of these program code blocks may be included in a given computing system.

The communication subsystem 393 of the computing device 300 may be embodied as any network interface controller or other communication circuit, device, or collection thereof, capable of enabling communications between the computing device 300 and other remote devices over a network. The communication subsystem 393 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 300 may also include one or more peripheral devices 395. The peripheral devices 395 may include any number of additional input/output devices, interface devices, and/or other peripheral devices. For example, in some embodiments, the peripheral devices 395 may include a display, touch screen, graphics circuitry, keyboard, mouse, speaker system, microphone, network interface, and/or other input/output devices, interface devices, GPS, camera, and/or other peripheral devices.

Of course, the computing device 300 may also include other elements (not shown), as readily contemplated by one of skill in the art, as well as omit certain elements. For example, various other sensors, input devices, and/or output devices can be included in computing device 300, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 300 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

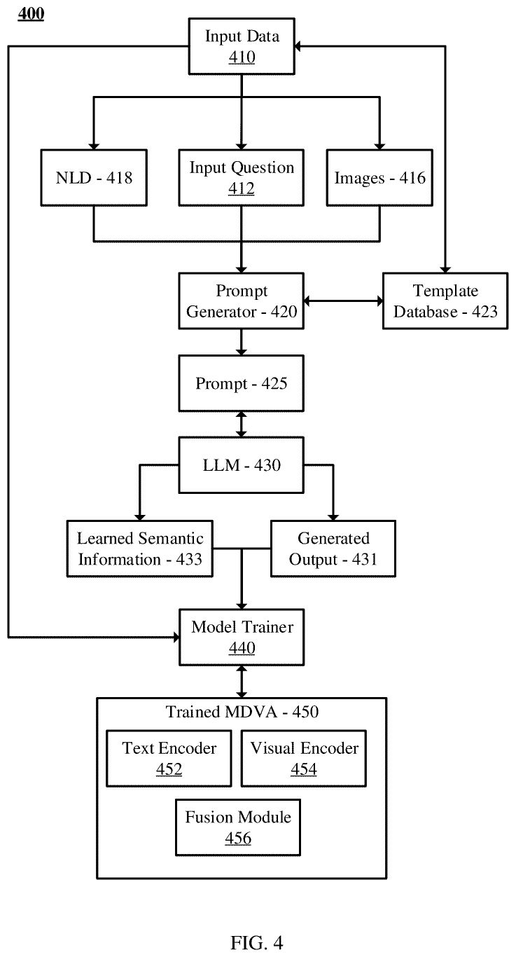

Referring now to FIG. 4, a block diagram showing a hardware and software components of leveraging semantic information for a multi-domain visual agent, in accordance with an embodiment of the present invention.

System 400 can process input data 410 that can include the NLD 418, input question 412, and images 416. The input data 410 can be obtained from the template database 323. The prompt generator 420 can receive the input data 410 to generate a prompt 425. The prompt 425 can be fed into the LLM 430 to generate generated output 431 and to learn learned semantic information 433. The generated output 431, and the input data 410 can be employed by the model trainer 440 to train the MDVA and obtain a trained MDVA 450. The trained MDVA 450 can include a text encoder 452, visual encoder 454, and fusion module 456.

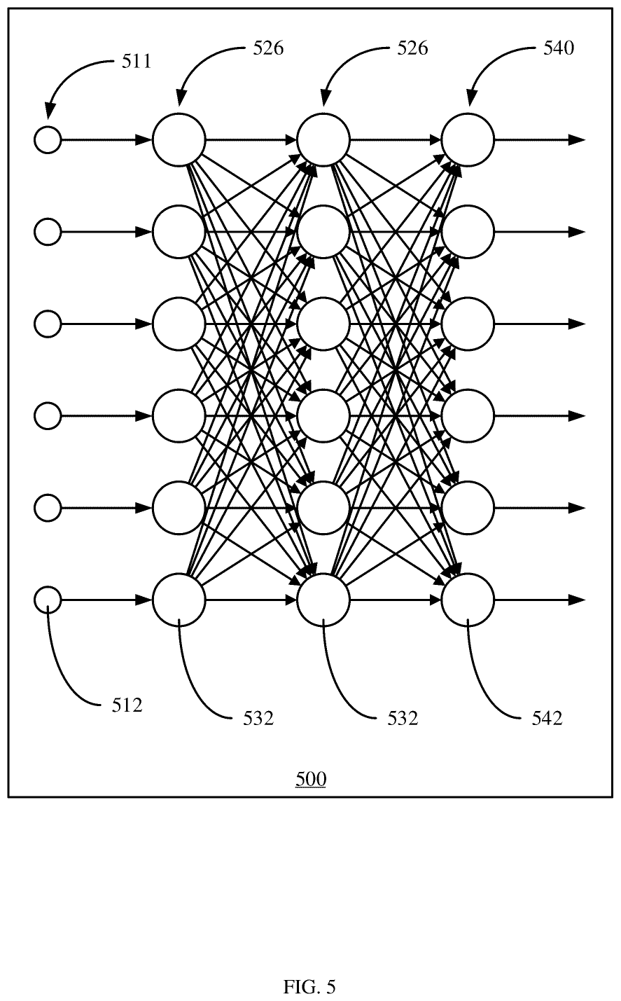

Referring now to FIG. 5, a block diagram illustrating deep learning neural networks for leveraging semantic information for a multi-domain visual agent, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the MDVA 311 can learn relationships between embeddings of an image 416 and NLD 418 and input question 412 313. The output layer 540 of the MDVA 311 can then provide the overall response of the network as a likelihood score of relevance of the image 416 and NLD 418 and input question 412. The relevance can be further used to learn the semantic information of the image 416, NLD 418 and input questions 412.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for leveraging semantic information for a multi-domain visual agent, comprising:
sampling questions from question templates for domain-specific label spaces to obtain a unified label space;
mapping domain-specific labels from the domain-specific label spaces into natural language descriptions (NLD) to obtain mapped NLD;
generating prompts by combining the questions sampled from the unified label space and the mapped NLD;
learning the semantic information by iteratively generating outputs from tokens extracted from the prompts using a large-language model (LLM); and
training the multi-domain visual agent (MDVA) using the semantic information to obtain a trained MDVA.

2. The computer-implemented method of claim 1, further comprising, generating a trajectory for a traffic scene that includes detected objects by the trained MDVA to control a vehicle.

3. The computer-implemented method of claim 1, further comprising transferring learned knowledge from one domain to another.

4. The computer-implemented method of claim 1, wherein sampling the questions further comprises determining the questions with sampling rules based on a commonality threshold.

5. The computer-implemented method of claim 1, wherein mapping the domain-specific labels further comprises determining similarities between word embeddings of the NLD and the domain-specific labels.

6. The computer-implemented method of claim 1, wherein generating the prompts further comprises generating prompt templates based on learned semantic information between each question, NLD, and input data.

7. The computer-implemented method of claim 1, wherein learning the semantic information further comprises verifying the learned semantic information by computing a loss function between generated outputs and ground truth data from the unified label space.

8. A system for leveraging semantic information for a multi-domain visual agent, comprising:
a memory device;
one or more processor devices operatively coupled with the memory device to:
sample questions from question templates for domain-specific label spaces to obtain a unified label space;
map domain-specific labels from the domain-specific label spaces into natural language descriptions (NLD) to obtain mapped NLD;
generate prompts by combining the questions sampled from the unified label space and the mapped NLD;
learn the semantic information by iteratively generating outputs from tokens extracted from the prompts using a large-language model (LLM); and
train the multi-domain visual agent (MDVA) using the semantic information to obtain a trained MDVA.

9. The system of claim 8, further comprising to generate a trajectory for a traffic scene that includes detected objects by the trained MDVA to control a vehicle.

10. The system of claim 8, further comprising to transfer learned knowledge from one domain to another.

11. The system of claim 8, wherein to sample the questions further comprises to determine the questions with sampling rules based on a commonality threshold.

12. The system of claim 8, wherein to map the domain-specific labels further comprises to determine similarities between word embeddings of the NLD and the domain-specific labels.

13. The system of claim 8, wherein to generate the prompts further comprises to generate prompt templates based on learned semantic information between each question, NLD, and input data.

14. The system of claim 8, wherein to learn the semantic information further comprises to verify the learned semantic information by computing a loss function between generated outputs and ground truth data from the unified label space.

15. A non-transitory computer program product comprising a computer-readable storage medium including program code for leveraging semantic information for a multi-domain visual agent, wherein the program code when executed on a computer causes the computer to:
sample questions from question templates for domain-specific label spaces to obtain a unified label space;
map domain-specific labels from the domain-specific label spaces into natural language descriptions (NLD) to obtain mapped NLD;
generate prompts by combining the questions sampled from the unified label space and the mapped NLD;
learn the semantic information by iteratively generating outputs from tokens extracted from the prompts using a large-language model (LLM); and
train the multi-domain visual agent (MDVA) using the semantic information to obtain a trained MDVA.

16. The non-transitory computer program product of claim 15, further comprising to generate a trajectory for a traffic scene that includes detected objects by the trained MDVA to control a vehicle.

17. The non-transitory computer program product of claim 15, further comprising to transfer learned knowledge from one domain to another.

18. The non-transitory computer program product of claim 15, wherein to sample the questions further comprises to determine the questions with sampling rules based on a commonality threshold.

19. The non-transitory computer program product of claim 15, wherein to map the domain-specific labels further comprises to determine similarities between word embeddings of the NLD and the domain-specific labels.

20. The non-transitory computer program product of claim 15, wherein to generate the prompts further comprises to generate prompt templates based on learned semantic information between each question, NLD, and input data.
